(19) United States
(12) Patent Application Publication
(10) Pub. No.: US 2005/0207967 A1
(43) Pub. Date: Sep. 22, 2005

(54) Porous carbon material and process for producing same

(76) Inventor: Tetsuro Yoshii, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/075,795

(22) Filed: Mar. 10, 2005

(30) Foreign Application Priority Data
Mar. 16, 2004 (JP) 074098/2004

(51) Int. Cl. C01B 31/02

(52) U.S. Cl. 423/461; 423/445 B

(57) ABSTRACT

There are disclosed a porous carbon material which comprises a fullerene crystal body and which has an average pore diameter of at least 100 nm that has never hitherto been realized; and a process for producing a porous carbon material which comprises subjecting a fullerene crystal body composed of at least two types of fullerenes each having a different molecular weight to an elution treatment by the use of a solvent which shows a relatively high solubility for at least one fullerene from among the fullerenes constituting the crystal body, and which shows a relatively low solubility for at least one fullerene other than the foregoing. The porous carbon material is preferably used as a carrier for corpuscular catalyst for a fuel cell and also as a base material of a modifying agent for a fuel cell and the like.

### BACKGROUND OF THE INVENTION

1. Field of the Invention

The present invention relates to a porous carbon material composed of a fullerene crystal body and a process for producing the porous carbon material. More particularly, it pertains to a porous carbon material which has a large average-pore-diameter and is composed of a fullerene crystal body, and a process for producing the porous carbon material.

2. Description of the Related Arts

Activated carbon is known as a porous carbon material. Activated carbon, which is mainly a material having pores with a diameter of 50 nm or smaller, is employed as an adsorbent. On the other hand, carbon fiber without pores is employed as a catalyst carrier for a fuel cell and the like.

In recent years for the sake of miniaturization and high efficiency of a fuel cell, it is required that corpuscular catalyst in a larger amount be supported on a porous carbon material in a smaller amount, thereby necessitating a porous carbon material having a pore structure on the surface or inside.

However since a corpuscular catalyst has a size ranging from several nm to several ten nm expressed in terms of diameter, while activated carbon, for instance, has a pore diameter comparable to or smaller than that of the corpuscular catalyst, it is impossible for the activated carbon to incorporate the corpuscular catalyst thereinto. Preferably, the porous carbon material has a pore diameter of larger than 100 nm in order to incorporate the corpuscular catalyst and also assure the passageway of a medium in contact with the corpuscular catalyst.

Most of the conventional porous carbon material has a pore diameter of smaller than 50 nm, so called mesodiameter. In the case of carbonaceous material having vacancy using zeolite as a mold material, nothing is known more than a material having a maximum pore diameter of about 100 nm (refer to Japanese Patent Application Laid-Open No. 29860/2002 (Heisei 14) and Japanese Patent Application Laid-Open No. 206112/2003 (Heisei 15)). The maximum pore diameter of about 100 nm gives rise to a problem that a substrate wherein a reaction is accelerated by a catalyst in the pore is less prone to transfer.

Moreover, porous carbon material which is disclosed in Japanese Patent Application Laid-Open No. 29860/2002 (Heisei 14) and Japanese Patent Application Laid-Open No. 206112/2003 (Heisei 15) involves a problem on production that the production process is complicated, since a gaseous organic matter is introduced in zeolite and thereafter a heat treatment at 800° C. or higher is carried out.

### SUMMARY OF THE INVENTION

In the light of the above-described circumstances, an object of the present invention is to provide a porous carbon material having an average pore diameter of at least 100 nm and a process for efficiently producing the foregoing porous carbon material.

In order to achieve the above-mentioned object, intensive extensive research and investigation were made by the present inventors. As a result, the following fact has been discovered. Utilizing that fullerenes each having a different molecular weight show a different solubility depending upon solvent, by subjecting a fullerene crystal body composed of at least two types of fullerenes each having a different molecular weight to an elution treatment in a solvent which shows a higher solubility for at least one fullerene and a lower solubility for at least one fullerene other than the foregoing, pores having an average pore diameter of at least 100 nm are formed on the surfaces of or inside the fullerene crystal body. It being so, the present invention has been accomplished by the foregoing findings and information.

Specifically the present invention provides the following.
1. A porous carbon material which comprises a fullerene crystal body and which has an average pore diameter of at least 100 nm;
2. The porous carbon material as set forth in the preceding item 1, wherein the fullerene crystal body is in the form of a rod having an aspect ratio of at least 2, a plate or a granule;
3. The porous carbon material as set forth in the preceding item 1, which is obtained by subjecting a fullerene crystal body composed of at least two types of fullerenes each having a different molecular weight to an elution treatment by the use of a solvent which shows a relatively high solubility for at least one fullerene from among the fullerenes constituting the crystal body, and which shows a relatively low solubility for at least one fullerene other than the foregoing;
4. The porous carbon material as set forth in the preceding item 3, wherein the ratio of the solubility of the fullerene showing a relatively high solubility to the solubility of the fullerene showing a relatively low solubility is at least 2;
5. The porous carbon material as set forth in the preceding item 3, wherein the content of the fullerene showing a relatively high solubility in the solvent is in the range of 0.5 to 10 mole % based on the total amount of fullerenes;
6. The porous carbon material as set forth in the preceding item 3, wherein at least two types of fullerenes each having a different molecular weight are composed substantially of a fullerene bearing 60 carbon atoms and a fullerene bearing 70 carbon atoms;
7. A process for producing a porous carbon material which comprises subjecting a fullerene crystal body composed of at least two types of fullerenes each having a different molecular weight to an elution treatment by the use of a solvent which shows a relatively high solubility for at least one fullerene from among the fullerenes constituting the crystal body, and which shows a relatively low solubility for at least one fullerene other than the foregoing;
8. The process for producing a porous carbon material as set forth in the preceding item 7, wherein the ratio of the solubility of the fullerene showing a relatively high solubility to the solubility of the fullerene showing a relatively low solubility is at least 2;
9. The process for producing a porous carbon material as set forth in the preceding item 7, wherein the content of the fullerene showing a relatively high solubility in the solvent is in the range of 0.5 to 10 mole % based on the total amount of fullerenes;
10. The process for producing a porous carbon material as set forth in the preceding item 7, wherein a fullerene crystal body composed of at least two types of fullerenes each having a different molecular weight is bonded by covalent bond and/or van del Waals' bond;
11. The process for producing a porous carbon material as set forth in the preceding item 7, wherein at least two types of fullerenes each having a different molecular weight are composed substantially of a fullerene bearing 60 carbon atoms and a fullerene bearing 70 carbon atoms;
12. The process for producing a porous carbon material as set forth in the preceding item 11, wherein the solvent is benzonitrile; and
13. The process for producing a porous carbon material as set forth in the preceding item 7, wherein the fullerene showing a relatively low solubility is dissolved in advance in a solvent.

### BRIEF DESCRIPTION OF THE DRAWINGS

FIG. 1 is a scanning electron microscope (SEM) micrograph of the surface of fibrous fullerene crystal before elution treatment;

FIG. 2 is a scanning electron microscope (SEM) micrograph of the porous carbon material produced in Example 1;

FIG. 3 is an electron beam diffraction pattern of the porous carbon material produced in Example 1;

FIG. 4 is a scanning electron microscope (SEM) micrograph of the porous carbon material produced in Example 2 (acceleration voltage of 10 kV, magnification factor of 10,000);

FIG. 5 is a scanning electron microscope (SEM) micrograph of the porous carbon material produced in Example 3 (acceleration voltage of 10 kV, magnification factor of 10,000); and

FIG. 6 is a scanning electron microscope (SEM) micrograph of the porous carbon material produced in Example 4 (acceleration voltage of 10 kV, magnification factor of 10,000).

### DESCRIPTION OF PREFERRED EMBODIMENTS

The porous carbon material according to the present invention comprises a fullerene crystal body. A fullerene is a molecule forming a spherical closed shell structure with at least 60 numbers of carbon atoms gathering together, and the carbon atoms themselves forming the fullerene are associated through covalent bond, which is constituted of a regular combination of five-membered ring and six-membered ring.

The C₆₀ fullerene known as a typical one among the above-mentioned fullerenes is in the form of a soccer ball which gathers 20 six-membered rings of carbon atoms so as to form 12 five-membered rings. C₆₀ Six-membered rings, when increased to 30 numbers, become C₇₀. It is known that by further increasing six-membered rings, it is made possible to form a further large spherical molecule or a long tube leading to C₇₆, C₇₈, C₈₂, C₂₄₀ and further to C_{540.}

The fullerene to be used as a starting material in the present invention is not specifically limited, but may be selected for use from fullerenes available on the market, which have preferably purity of at least 95%, more preferably of at least 98%.

The porous carbon material according to the present invention contains at least two types of fullerenes each having a different molecular weight in the production stage as described hereinafter, but may be finally composed of single one fullerene crystal body or of a plurality of fullerene crystal bodies.

The shape of the fullerene crystal body relating to the present invention is not specifically limited, but may be properly optionally selected according to the purpose of use. Specific shape thereof is exemplified by a rod having an aspect ratio of at least 2, fiber having an aspect ratio of at least 10, a plate or a granule.

The process for the production of the fullerene crystal having such shape is not specifically limited, but a previously well known process is usable. For instance, by controlling each of solvents, a fullerene crystal is obtained which has a shape of a rod, a fiber, a plate or a granule. More specifically, preferable examples of the solvents for forming rod-shaped or fiber-shaped fullerene crystal include toluene; halogenated benzenes in liquid form at 0° C. such as chlorobenzene; anisole; m-xylene; benzene compounds having substituents at meta positions such as m-dichlorobenzene; benzene compounds having substituents at 1, 3, 5 positions such as 1,3,5-trimethylbenzene. The substituents at meta positions and 1, 3, 5 positions may be the same as or different from each other.

Preferable examples of the solvents for forming plate-shaped fullerene crystal include o-xylene; benzene compounds having substituents at ortho positions such as o-dichlorobenzene; benzene compounds having substituents at 1, 2, 4 positions such as 1,2,4-trimethylbenzene. The substituents at orhto positions and 1, 2, 4 positions may be the same as or different from each other.

Preferable examples of the solvents for forming granular fullerene crystal include p-xylene; benzene compounds having substituents at para positions such as p-dichlorobenzene; benzene compounds having substituents at 1, 2, 3 positions such as 1,2,3-trimethylbenzene. The substituents at para positions and 1, 2, 3 positions may be the same as or different from each other.

The size of the fullerene crystal is not specifically limited, but may be properly optionally selected according to the purpose of use. The fullerene crystal in rod-shape or fiber-shape has an average diameter of usually 0.2 to 10 μm, preferably 0.5 to 1 μm and an average length of usually at least 1 μm, preferably at least 5 μm. The fullerene crystal in plate-shape has an average major axis diameter of usually at least 1 mm, an average thickness of about 1 to 10 μm. The fullerene crystal in granule-shape has an average diameter of usually at least 0.1 μm, preferably at least 0.5 μm.

The porous carbon material according to the present invention is characterized by having an average pore diameter of at least 100 nm, whereby active ingredients of a catalyst are effectively supported and at the same time, efficiently function as fields of reaction. The upper limit of the average pore diameter thereof is not specifically limited. For the purpose of assuring the strength as catalyst carrier, in the case of rod- or fiber-shape, the upper limit is preferably at most one tenth of the average diameter thereof, in the case of plate-shape, it is preferably at most one tenth of the average thickness, and in the case of granule-shape, it is preferably at most one tenth of the average particle diameter thereof.

The process for the production of the porous carbon material according to the present invention is not specifically limited, but the process described hereunder enables efficient production. Specifically the process comprises subjecting a fullerene crystal body composed of at least two types of fullerenes each having a different molecular weight to an elution treatment by the use of a solvent which shows a relatively high solubility for at least one fullerene from among the fullerenes constituting the crystal body, and which shows a relatively low solubility for at least one fullerene other than the foregoing.

In the following, the process will be described in detail.
(1) In the first place, by the use of a good solvent which dissolves all of fullerenes as starting materials composed of at least two types of fullerenes each having a different molecular weight, a fullerene solution is prepared (hereinafter referred to as Mixed fullerene solution). In the case of preparing the Mixed fullerene solution in this step by dissolving in a good solvent at least two types of fullerenes each having a different molecular weight, in order to control the mixing ratio of the fullerenes it is preferable to dissolve each of the fullerenes individually in a good solvent and thereafter mix the same according to the mixing ratio. In this case by almost saturating the fullerene concentration of each of the fullerene solutions, it is possible to more accurately control the mixing ratio of each fullerene in the Mixed fullerene solution.

The type of fullerene is not specifically limited, but it is preferable to use C₆₀ as the fullerene to be the base material, and C₇₀ as the fullerene to be eluted in the post step for forming pores taking into consideration ease of availability, cost and the like. The good solvent is not specifically limited, provided that it similarly dissolves at least two fullerenes, but is preferably exemplified by for instance, m-xylene, o-xylene and 1,3,5-trimthylbenzene.
(2) Subsequently, the above-prepared Mixed fullerene solution is added to a poor solvent to crystallize fullerene crystals. The poor solvent means a solvent of a low solubility. In this step by adding a poor solvent to the Mixed fullerene solution to lower the solubility of the fullerenes, fullerene crystals are deposited which are constituted of covalent bond or van der Waals bond. In this case in order to lower the solubility of the fullerenes and facilitate the crystallization thereof, the Mixed fullerene solution and poor solvent are preferably kept at a low temperature, specifically usually 20° C. or lower, preferably 10° C. or lower, but not lower than the solidifying point of the solvent in question.

The concentration of each of the fullerenes in the Mixed fullerene solution is not specifically limited, but is preferably a concentration at which the fullerene is not deposited in a crystallization step and besides, in order to facilitate crystallization upon adding a poor solvent, it is preferable to set the concentration thereof on at least 50% of saturation concentration.

The poor solvent is not specifically limited in the type provided that it is capable of depositing fullerene crystals. There are usually usable n-propanol, isopropanol, various butyl alcohol and various pentyl alcohol, which should be properly used according to the configuration of crystals. There are preferably used isopropanol, 2-butyl alcohol, 2-pentyl alcohol and the like to obtain crystals of fiber fom; isopropanol, 2-butyl alcohol, 1-pentyl alcohol, 2-pentyl alcohol and the like to obtain crystals of plate form; and n-propanol, n-butyl alcohol, 2-butyl alcohol, 1-pentyl alcohol, 2-pentyl alcohol and the like to obtain crystals of granule form.

The poor solvent is gradually slowly added to the fullerene solution so as not to mix therewith to constitute a two-layer structure of the fullerene solution and the poor solvent, whereupon the ratio by volume of the solvent to the solution is preferably 1 or more, more preferably 3 or more. The resultant solution is allowed to stand for usually about 24 hours, preferably 48 hours or longer at a prescribed temperature. In this state, mutual diffusion is caused by the fullerene solution and the poor solvent, so that fullerene crystals in the fullerene solution are deposited. Preferably, the deposited fullerene crystals are dried at a temperature of usually 50° C. or higher and thereafter, heat treated at a temperature of 250° C. or lower for 1 hour or more. By the above-stated step, the solvent which has been incorporated in the crystals evaporates, whereby the elution of the fullerene stably takes place in the subsequent step.
(3) Subsequently, pores are formed by treating the deposited fullerene crystal with an elution solvent. Herein the elution solvent means a solvent which shows a relatively high solubility for at least one fullerene from among at least two fullerenes, and which shows a relatively low solubility for at least one fullerene other than the foregoing. For instance, in the case where the fullerene to be eluted is C₇₀ and the fullerene to be the base material of the porous body is C₆₀, benzonitrile, toluene and the like are preferably used. Preferably, the fullerene which remains as a base material is excessively dissolved in advance in the above-mentioned elution solvent to form a state wherein the fullerene for the base material is saturated or almost saturated, so that the fullerene for the base material is substantially no longer dissolved.

In the case where the fullerene to be eluted is C₇₀, the fullerene to be the base material of the porous body is C₆₀, the molar ratio of C₆₀ to C₇₀ is 98:2, and toluene is used as the elution solvent in which the C₆₀ is dissolved in a saturated state, the fullerene C₆₀ is no longer dissolved therein, while fullerene C₇₀ only is selectively dissolved.

Period of time for immersing the fullerene crystal in the elution solvent is not specifically limited, but can be properly optionally controlled according to pore diameter and the number of pores that are required. A small pore-diameter or less number of pores, when desirable, is attainable by properly controlling the immersion time usually within 24 hours. On the other hand, when it is desired to sufficiently elute the fullerene components to be eluted, the immersion time is preferably usually 24 hours or longer, more preferably 48 hours or longer. The conditions of temperature are not specifically limited, but the elution is performed preferably at a temperature same as the temperature at which the fullerene crystals were grown from the viewpoint of preventing the crystal from being deposited by temperature variation, and excessively dissolved.

In the present step, by subjecting the deposited fullerene crystals to the elution treatment in the elution solvent, the fullerene showing a high solubility for the elution solvent is eluted in the elution solvent, whereas the fullerene showing a low solubility for the elution solvent is not eluted therein, or slightly eluted to the extent of maintaining the shape of porous body with a result that pores having a pore diameter of at least 100 nm are formed on the surfaces of or inside the fullerene crystal, whereby the objective porous carbon material is obtainable.

In the case of producing the porous carbon material according to the present invention through the above-mentioned steps, the content of the fullerene having a relatively high solubility for the elution solvent is preferably in the range of 0.5 to 10 mole %. By setting the content just mentioned on at least 0.5 mole %, a sufficient amount of pores having a pore diameter of at least 100 nm is obtainable. On the other hand, by setting the foregoing content on at most 10 mole %, it is made possible to maintain the skeleton of fullerene crystals which have created pores and also to preferably obtain the crystals with sufficient strength. In view of the foregoing, the content of the fullerene having a relatively high solubility for the elution solvent is more preferably in the range of 1 to 5 mole %.

In addition, by controlling the content of the fullerene having a relatively high solubility for the elution solvent in the above-defined preferable range, the number of pores to be formed can be controlled. For instance, the number of pores to be formed in the elution step increases with an increase in the mixing ratio of the fullerene to be eluted.

Further, the diameters of pores to be formed in the elution step can be controlled by controlling the solvent temperature and elution time upon elution treatment, the concentration of the fullerene for the base material to be dissolved in advance in the elution solvent and the like. That is to say, it follows that when the amount of the fullerene to be eluted is controlled to an increasing amount, the pores to be formed are imparted with a larger pore diameter. In particular, pores having a large pore diameter are formed by controlling so as to cause dissolution of the fullerene to be the base material.

The working effect and industrial applicability of the porous carbon material according to the present invention are summarized as follows. The porous carbon material according thereto has an average pore diameter of at least 100 nm which has never hitherto been obtained and accordingly, can preferably support a corpuscular catalyst and thus, can preferably be used as a catalyst carrying body for fuel cells and carrying body for catalyst and enzyme in a micro flow path and the like. Moreover since the porous carbon material has a pore diameter enabling the base material causing reaction to sufficiently move in the pores, it is made possible to treat in high efficiency, a fluid that is the object of causing catalytic reaction and besides, to use the material in a high temperature environment because of its being composed only of carbon.

According to the production process of the porous carbon material of the present invention, it is possible to produce in high efficiency, the porous carbon material having an average pore diameter of at least 100 nm of the invention which has never hitherto been obtained.

Further, a variety of applications are expected for the porous carbon material owing to the characteristics of having pore diameter of at least 100 nm in spite of its being a carbon material. For instance, the carbon material composed of porous fullerene crystal of the invention, which is easily made into a fibrous crystal configuration, can be made into a catalyst carrying body which supports corpuscular catalyst in the pores by way of paper making. The carbon material, which is excellent in resistance to acids and alkalis because of its inherent properties, can be used as a base material of modifying agent for fuel cells and the like.

Furthermore, with regard to flow system reaction in which two or more starting materials are more prone to become laminar flow whereby insufficient contact therebetween is likely to occur, by using the porous carbon material of the present invention as carrying body for the corpuscular catalyst, such working effects are expected that pores having a diameter of at least 100 nm provide a field of reaction, increase the contact proportion among the starting materials and contact proportion between the starting materials and catalyst, and thus accelerate the reaction.

In the following, the present invention will be described in more detail with reference to working examples, which however shall never limit the present invention thereto.

### Example 1

Fullerene C₆₀ in an amount of 0.12 g was dissolved in 100 mL (milliliter) of m-xylene, separate fullerene C₇₀ in an amount of 0.12 g was dissolved in 100 mL of m-xylene, and 19 mL of the resultant fullerene C₆₀ solution and 1 mL of the fullerene C₇₀ solution were placed in a 50 mL lidded bottle and mixed to prepare a mixed fullerene solution. The resultant mixed fullerene solution was cooled to 10° C., 30 mL of isopropanol which had been cooled to 10° C. separately was allowed to slowly flow in the above-mentioned mixed fullerene solution so as to form a liquid-liquid interface, thereby forming a state wherein an isopropanol layer is present in the upper portion and the mixed fullerene solution is present in the lower portion, and the resultant mixture was allowed to stand and preserved in a dark place at 10° C. for 48 hours. When the mixture was taken out after 48 hours, a large number of fibrous crystals had been deposited in the mixed fullerene solution. The fibrous crystals were taken out through filtration, washed with isopropanol, heated at 250° C. for 2 hours, thereafter placed in a 50 mL lidded bottle, in which was added 2 mL of benzonitrile, and was allowed to stand and preserved in a dark place at 10° C. for 48 hours. When the the benzonitrile which was inherently transparent was taken out after 48 hours, it became brown colored. The fibrous crystals were taken out from the bottle, heated at 200° C. for 3 hours to evaporate off the benzonitrile, so that porous fibrous crystals were obtained.

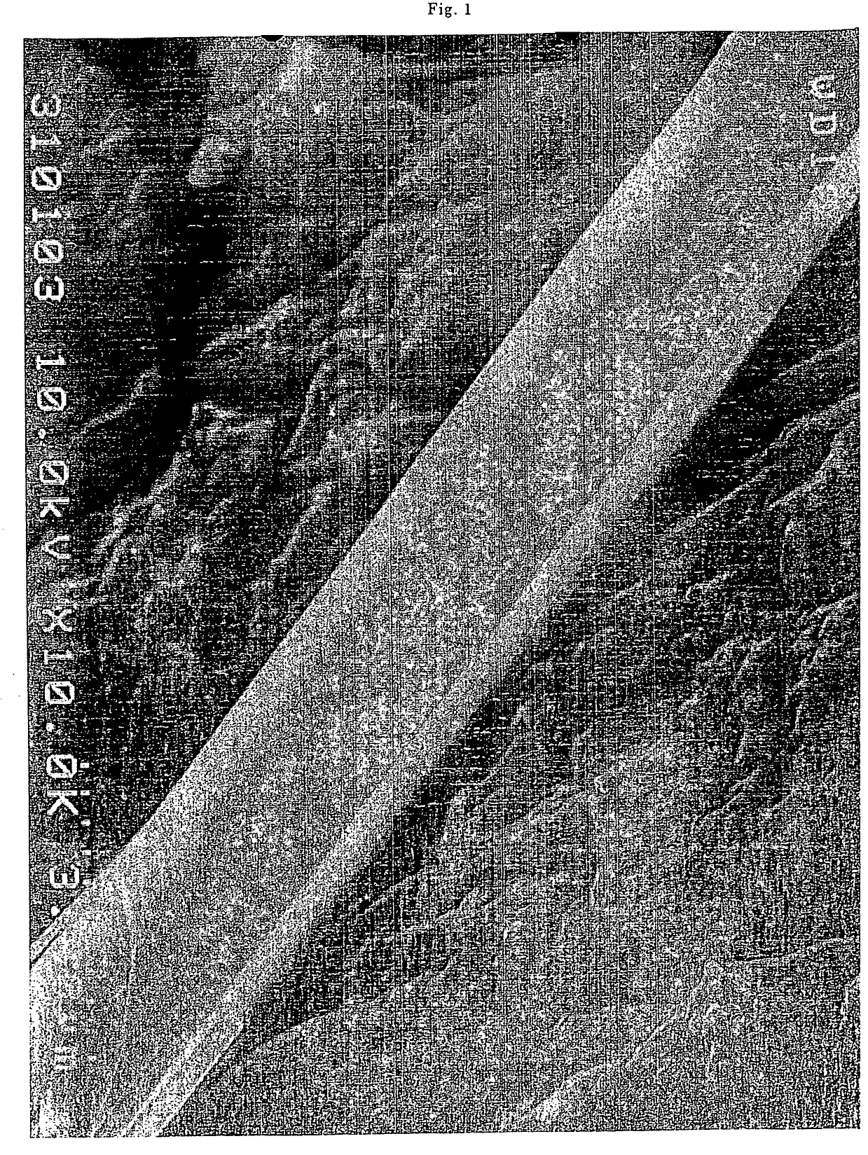

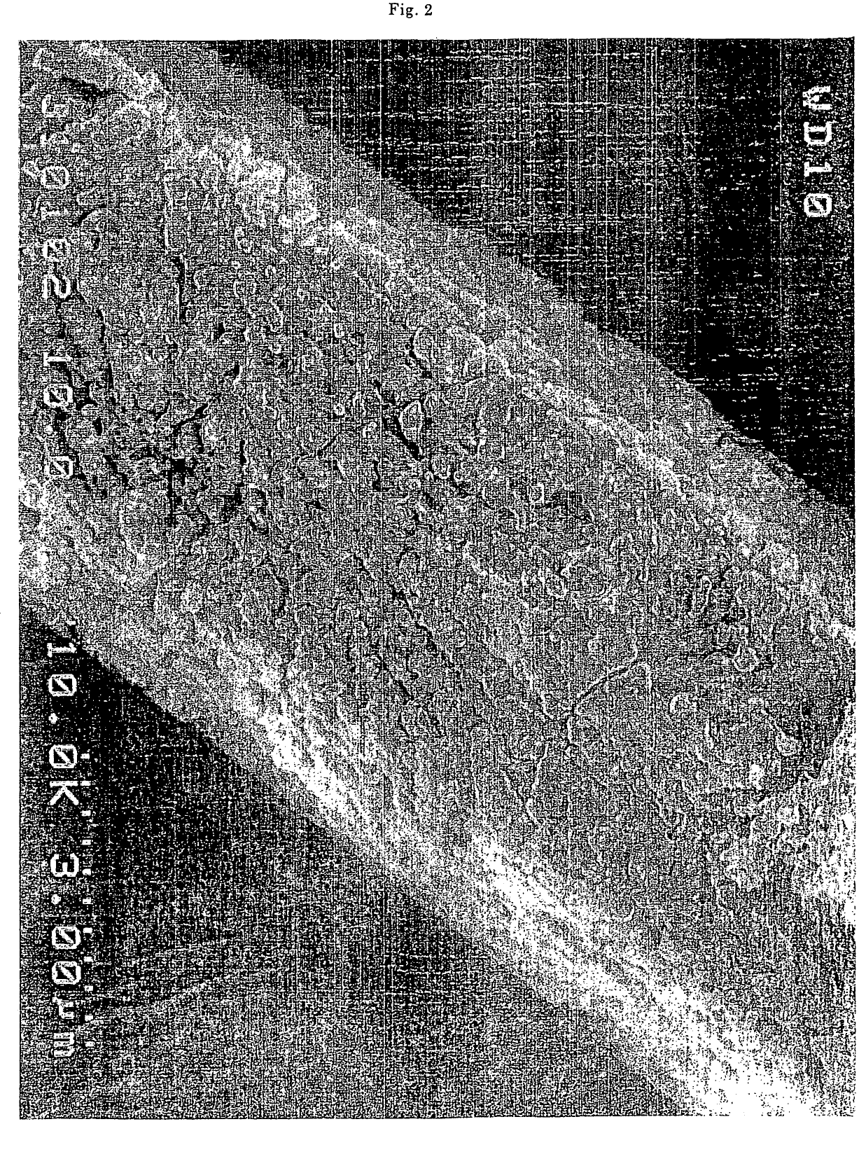

The surface conditions of the carbon fibers before and after the elution treatment are shown with scanning electron microscope (SEM) micrograph in FIG. 1 (before the elution treatment) and FIG. 2 (after the elution treatment). The photographing conditions for SEM micrograph included electron beam acceleration voltage of 10 kV and a magnification factor of 10,000.

Pore was not observed on the surface of the fullerene crystal body before the elution treatment, but pore constitution was recognized on the surface thereof after the elution treatment. The average pore diameter, which was measured by a mercury jetting method in accordance with JIS R 1665, resulted in 200 nm. It was confirmed that the average pore diameter was 200 nm, approximately with the SEM micrograph as well.

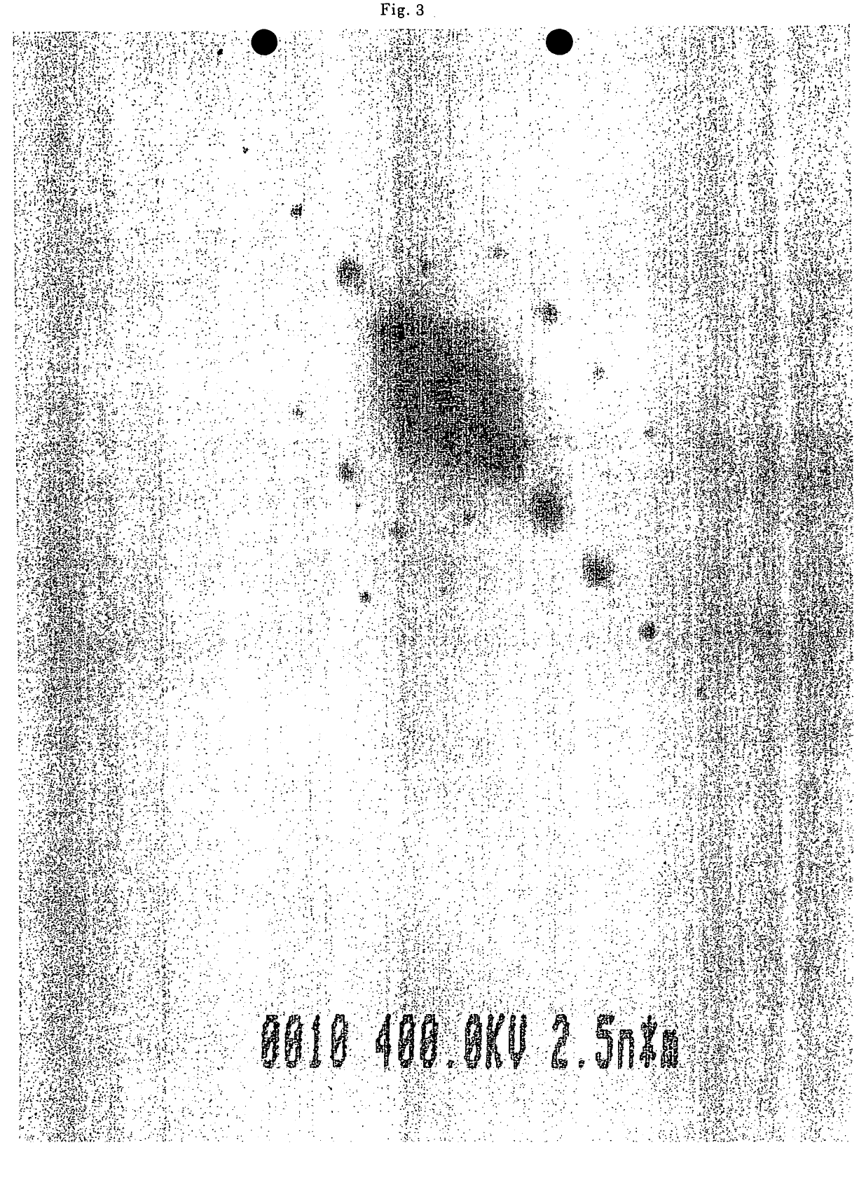

Moreover, in regard to the result of electron beam diffractometry after the elution treatment as shown in FIG. 3, diffraction spots due to crystalline structure were recognized and thereby it was confirmed that the crystalline structure of the fullerene crystal was assured (electron beam acceleration voltage of 400 kV).

### Example 2

Fullerene C₆₀ in an amount of 0.6 g was dissolved in 1.00 m L of o-xylene, separate fullerene C₇₀ in an amount of 0.6 g was dissolved in 100 mL of o-xylene, and 19.0 mL of the resultant fullerene C₆₀ solution and 1.0 mL of the fullerene C₇₀ solution were placed in a 50 mL lidded bottle and mixed to prepare a mixed fullerene solution. The resultant mixed fullerene solution was cooled to 10° C., 30 mL of 2-butanol which had been cooled to 10° C. separately was allowed to slowly flow in the above-mentioned mixed fullerene solution so as to form a liquid-liquid interface, thereby forming a state wherein a 2-butanol layer is present in the upper portion and the mixed fullerene solution is present in the lower portion, and the resultant mixture was allowed to stand and preserved in a dark place at 10° C. for 48 hours. When the mixture was taken out after 48 hours, a large number of plate-shaped crystals had been deposited in the mixed fullerene solution. The plate-shaped crystals were taken out through filtration, washed with 2-butanol, heated at 250° C. for 2 hours, thereafter placed in a 50 mL lidded bottle, in which was added 2 mL of toluene almost saturated with fullerene C₆₀, and was allowed to stand and preserved in a dark place at 10° C. for 48 hours.

When the toluene which was inherently purple was taken out after 48 hours, it became brown colored. The plate-shaped crystals were taken out from the bottle, heated at 200° C. for 3 hours to evaporate off the toluene, so that porous plate-shaped crystals were obtained.

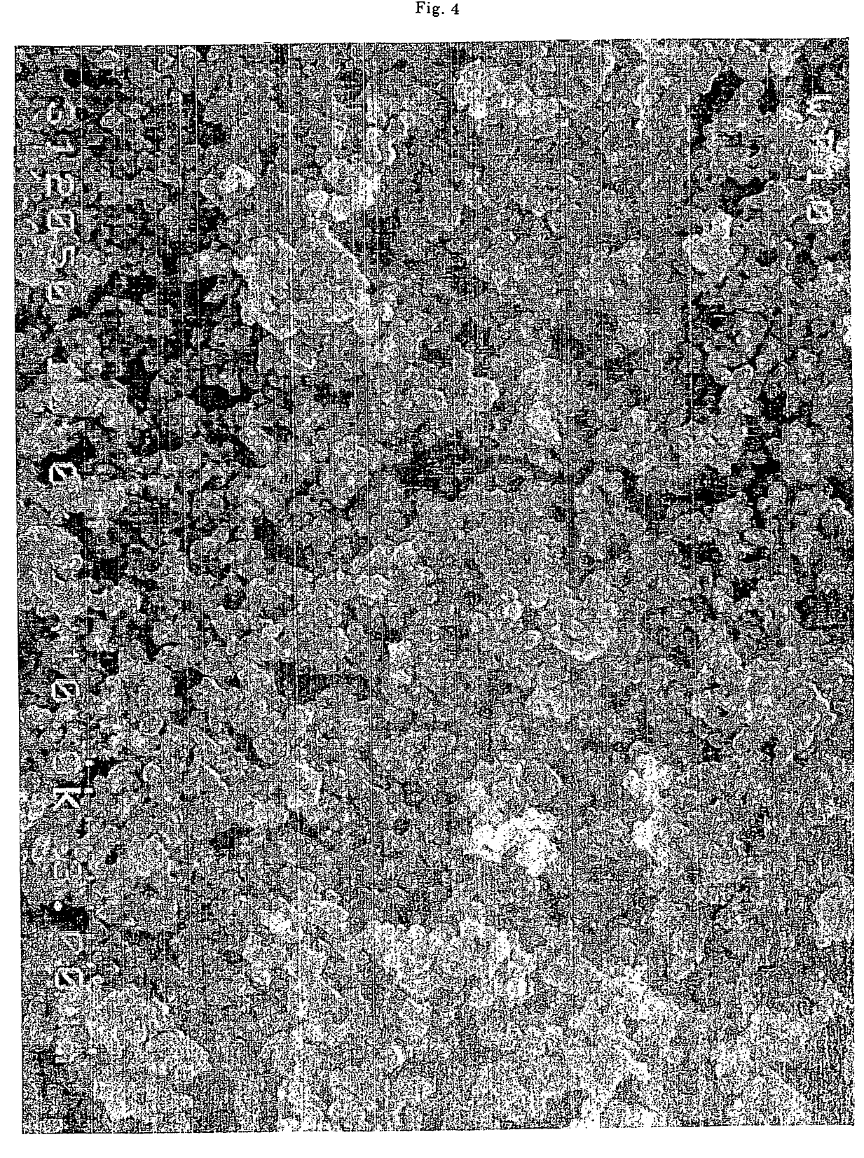

A SEM micrograph was taken in the same manner as the description in Example 1. As a result, pore constitution was recognized to have been formed on the surface of the fullerene crystal as shown in FIG. 4 as was the case with Example 1. The average pore diameter, which was measured in the same manner as the description in Example 1, resulted in 600 nm.

### Example 3

Fullerene C₆₀ in an amount of 0.1 g was dissolved in 100 mL of 1,3,5-trimethylbenzene, separate fullerene C₇₀ in an amount of 0.1 g was dissolved in 100 mL of 1,3,5-trimethylbenzene, and 19.5 mL of the resultant fullerene C₆₀ solution and 0.5 mL of the fullerene C₇₀ solution were placed in a 50 mL lidded bottle and mixed to prepare a mixed fullerene solution. The resultant mixed fullerene solution was cooled to 10° C., 6 mL of 2-butanol which had been cooled to 10° C. separately was allowed to slowly flow in the above-mentioned mixed fullerene solution so as to form a liquid-liquid interface, thereby forming a state wherein a 2-butanol layer is present in the upper portion and the mixed fullerene solution is present in the lower portion, and the resultant mixture was allowed to stand and preserved in a dark place at 10° C. for 60 hours.

When the mixture was taken out after 60 hours, a large number of fibrous crystals had been deposited in the mixed fullerene solution. The fibrous crystals were taken out through filtration, washed with 2-butanol, heated at 250° C. for 2 hours, thereafter placed in a 5 mL lidded bottle, in which was added 1 mL of benzonitrile, and was allowed to stand and preserved in a dark place at 10° C. for further 48 hours. When the benzonitrile which was inherently transparent was taken out after 48 hours, it became brown colored. The fibrous crystals were taken out from the bottle, heated at 200° C. for 3 hours to evaporate off the benzonitrile, so that porous fibrous crystals were obtained.

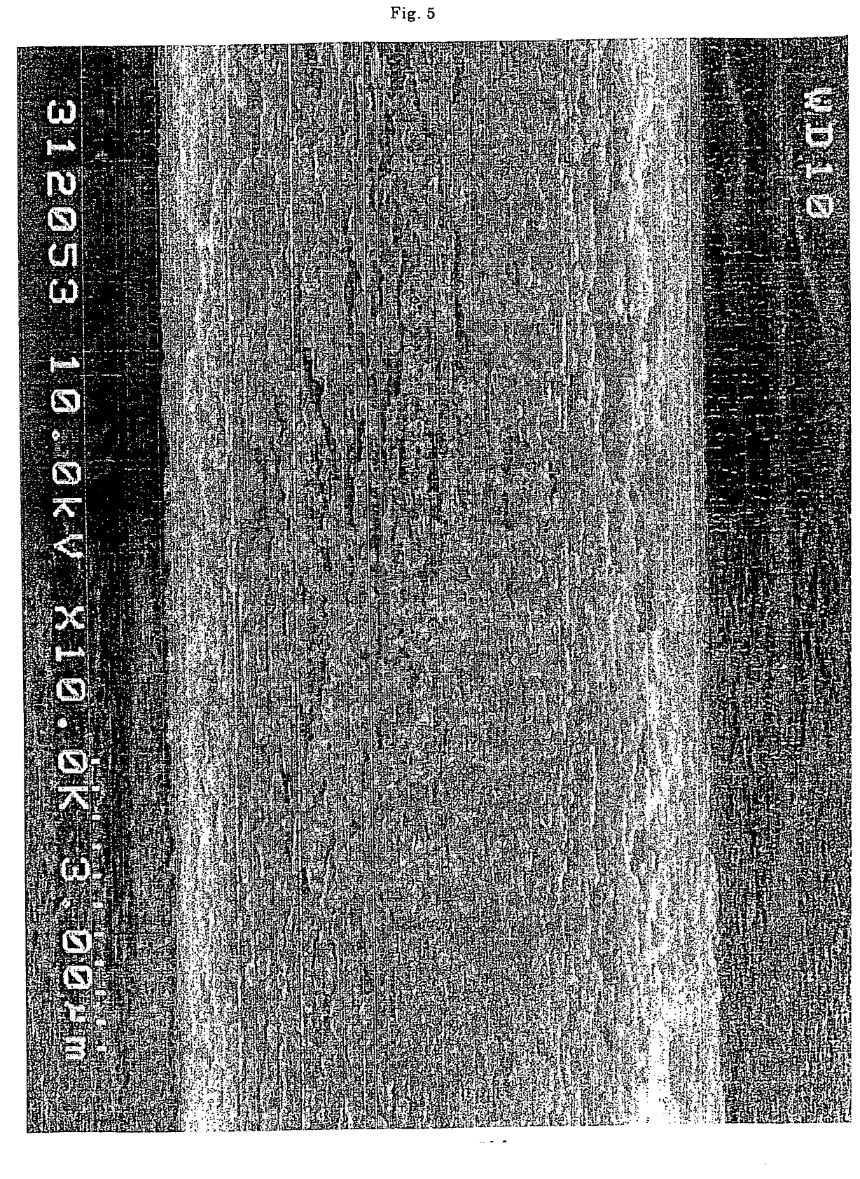

A SEM micrograph was taken in the same manner as the description in Example 1. As a result, pore constitution was recognized to have been formed on the surface of the fullerene crystal along the stretching direction of fibers as shown in FIG. 5 as was the case with Example 1. The average pore diameter, which was measured in the same manner as the description in Example 1, resulted in 500 nm.

### Example 4

Fullerene C₆₀ in an amount of 0.1 g was dissolved in 100 mL of 1,3,5-trimethylbenzene, separate fullerene C₇₀ in an amount of 0.1 g was dissolved in 100 mL of 1,3,5-trimethylbenzene, and 19.5 mL of the resultant fullerene C₆₀ solution and 0.5 mL of the fullerene C₇₀ solution were placed in a 50 mL lidded bottle and mixed to prepare a mixed fullerene solution. The resultant mixed fullerene solution was cooled to 10° C., 6 mL of 2-butanol which had been cooled to 10° C. separately was allowed to slowly flow in the above-mentioned mixed fullerene solution so as to form a liquid-liquid interface, thereby forming a state wherein a 2-butanol layer is present in the upper portion and the mixed fullerene solution is present in the lower portion, and the resultant mixture was allowed to stand and preserved in a dark place at 10° C. for 60 hours.

When the mixture was taken out after 60 hours, a large number of fibrous crystals had been deposited in the mixed fullerene solution. The fibrous crystals were taken out through filtration, washed with 2-butanol, heated at 250° C. for 2 hours, thereafter placed in a 5 mL lidded bottle, in which was added 1 mL of benzonitrile which was almost saturated with fullerene C₆₀, and was allowed to stand and preserved in a dark place at 10° C. for further 48 hours. When the benzonitrile which was inherently transparent was taken out after 48 hours, it became brown colored. The fibrous crystals were taken out from the bottle, heated at 200° C. for 3 hours to evaporate off the benzonitrile, so that porous fibrous crystals were obtained.

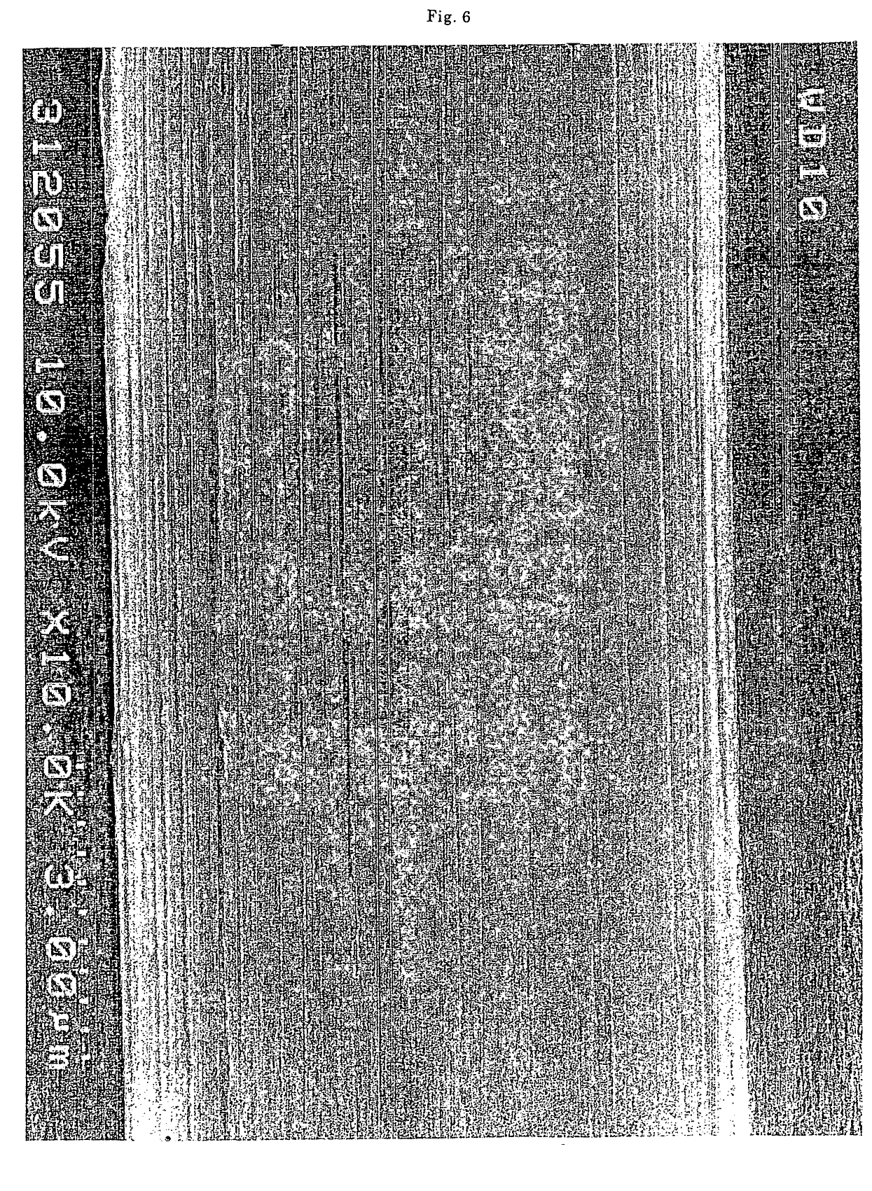

A SEM micrograph was taken in the same manner as the description in Example 1. As a result, pore constitution was recognized to have been formed on the surface of the fullerene crystal along the stretching direction of fibers as shown in FIG. 6 as was the case with Example 1. The average pore diameter, which was measured in the same manner as the description in Example 1, resulted in 100 nm.

1. A porous carbon material which comprises a fullerene crystal body and which has an average pore diameter of at least 100 nm.

2. The porous carbon material according to claim 1, wherein the fullerene crystal body is in the form of a rod having an aspect ratio of at least 2, a plate or a granule.

3. The porous carbon material according to claim 1, which is obtained by subjecting a fullerene crystal body composed of at least two types of fullerenes each having a different molecular weight to an elution treatment by the use of a solvent which shows a relatively high solubility for at least one fullerene from among the fullerenes constituting the crystal body, and which shows a relatively low solubility for at least one fullerene other than the foregoing.

4. The porous carbon material according to claim 3, wherein the ratio of the solubility of the fullerene showing a relatively high solubility to the solubility of the fullerene showing a relatively low solubility is at least 2.

5. The porous carbon material according to claim 3, wherein the content of the fullerene showing a relatively high solubility in the solvent is in the range of 0.5 to 10 mole % based on the total amount of fullerenes.

6. The porous carbon material according to claim 3, wherein at least two types of fullerenes each having a different molecular weight are composed substantially of a fullerene bearing 60 carbon atoms and a fullerene bearing 70 carbon atoms.

7. A process for producing a porous carbon material which comprises subjecting a fullerene crystal body composed of at least two types of fullerenes each having a different molecular weight to an elution treatment; by the use of a solvent which shows a relatively high solubility for at least one fullerene from among the fullerenes constituting the crystal body, and which shows a relatively low solubility for at least one fullerene other than the foregoing.

8. The process for producing a porous carbon material according to claim 7, wherein the ratio of the solubility of the fullerene showing a relatively high solubility to the solubility of the fullerene showing a relatively low solubility is at least 2.

9. The process for producing a porous carbon material according to claim 7, wherein the content of the fullerene showing a relatively high solubility in the solvent is in the range of 0.5 to 10 mole % based on the total amount of fullerenes.

10. The process for producing a porous carbon material according to claim 7, wherein a fullerene crystal body composed of at least two types of fullerenes each having a different molecular weight is bonded by covalent bond and/or van del Waals' bond.

11. The process for producing a porous carbon material according to claim 7, wherein at least two types of fullerenes each having a different molecular weight are composed substantially of a fullerene bearing 60 carbon atoms and a fullerene bearing 70 carbon atoms.

12. The process for producing a porous carbon material according to claim 11, wherein the solvent is benzonitrile.

13. The process for producing a porous carbon material according to claim 7, wherein the fullerene showing a relatively low solubility is dissolved in advance in a solvent.
